(19) United States
(12) Patent Application Publication
(10) Pub. No.: US 2010/0206337 A1
(43) Pub. Date: Aug. 19, 2010

(54) SUBSTRATE PROCESSING METHOD, SUBSTRATE PROCESSING APPARATUS, PROGRAM, STORAGE MEDIUM, AND SUBSTITUTE AGENT

(75) Inventors: Koukichi Hiroshiro, Saga-Ken (JP); Takayuki Toshima, Kumamoto-ken (JP)

Correspondence Address: BURR & BROWN, PO BOX 7068, SYRACUSE, NY, 13261-7068, US

(73) Assignee: Tokyo Electron Limited, Minato-Ku (JP)

(21) Appl. No.: 12/671,338

(22) PCT Filed: Jul. 24, 2008
(86) PCT No.: PCT/JP2008/063263

§ 371 Date: Jan. 29, 2010

(30) Foreign Application Priority Data
Aug. 3, 2007 (JP) 2007-202835

(51) Int. Cl. B08B 3/00

(52) U.S. Cl. 134/26; 134/95.2

(57) ABSTRACT

There is provided a substrate processing method with the use of plural kinds of liquids, capable of, after a process to a substrate by using a process liquid, rapidly and more reliably substituting the process liquid remaining on the substrate with a liquid to be subsequently used. The substrate processing method comprises: processing a substrate W by a process liquid; and supplying a substitute liquid onto the substrate and substituting the process liquid remaining on the substrate with the substitute liquid. The substitute liquid used in the substituting step has a surface tension that is smaller than a surface tension of the water, and a density that is equal to a density of the process liquid.

### FIELD OF THE INVENTION

The present invention relates to a substrate processing method for processing a substrate, in particular, to a substrate processing method capable of, after a process to a substrate by using a process liquid, rapidly and more reliably substituting the process liquid remaining on the substrate with a substitute liquid.

In addition, the present invention relates to a substrate processing apparatus for processing a substrate, in particular, to a substrate processing apparatus capable of, after a process to a substrate using a process liquid, rapidly and more reliably substituting the process liquid remaining on the substrate with a substitute liquid.

Further, the present invention relates to a program and a storage medium storing the program that is configured to perform a substrate processing method for processing a substrate, which is capable of, after a process to a substrate using a process liquid, rapidly and more reliably substituting the process liquid remaining on the substrate with a substitute liquid.

Furthermore, the present invention relates to a substitute agent to be supplied onto an object to be processed, so as to be substituted for a liquid remaining on a surface of the object to be processed, in particular, to a substitute agent capable of being rapidly and more reliably substituted for the liquid.

### BACKGROUND ART

It is general to process, for example, a substrate such as a semiconductor wafer (hereinafter referred to simply as “wafer”) and a glass substrate for display, with the use of plural kinds of liquids. As one example, during a manufacturing process of a semiconductor device, a wafer is subjected to a cleaning process using plural kinds of liquids for a plurality of times.

A substrate processing method (wafer cleaning method) disclosed in JP2003-297794A includes a processing step by means of a chemical liquid, a rinsing step by using a deionized water, a substituting step in which the deionized water is substituted with a desiccating agent, and a drying step for drying a substrate. On the other hand, a substrate processing method (wafer cleaning method) disclosed in JP2005-5469A includes a processing step by means of a chemical liquid, a substituting step in which the chemical liquid is substituted with a desiccating agent, and a drying step for drying a substrate. Namely, in the cleaning method disclosed in JP2005-5469A, a rinsing step by means of a deionized water is omitted, but the substrate is rinsed by substituting the chemical liquid with the desiccating agent.

In such a process to a substrate using plural kinds of liquids, it is preferable, in terms of production efficiency, that a liquid remaining on the substrate can be substituted for a short period of time with another kind of liquid to be subsequently used. On the contrary, if the liquid which has been used in the preceding process remains on the substrate for a long period of time, not only the production efficiency problem but also the quality problem may occur. For example, in the processes of JP2003-297794A and JP2005-5469A, when the chemical liquid remains on the substrate for a long period of time, the substrate is locally processed by the chemical liquid only at a position on which the chemical liquid remains. Namely, in the surface of one substrate, and/or the surfaces of the plurality of substrates, the degree of progress of the process becomes non-uniform. In addition, when a deionized water remains on the substrate for a long period of time, a problem may occur in that the remaining deionized water reacts with oxygen and the substrate (silicon) so as to generate watermarks on the substrate.

In consideration of the recent miniaturization of a circuit pattern of a semiconductor device, it becomes more and more important in the future to make it possible that a process liquid can be more reliably substituted for a short period of time, in both a single-wafer type process and a batch type process.

### DISCLOSURE OF THE INVENTION

That is to say, the present invention has been made in view of the above circumstances. The object of the present invention is to provide a substrate processing method and a substrate processing apparatus, capable of, after a process to a substrate using a liquid (process liquid), rapidly and more reliably substituting the liquid remaining on the substrate with a liquid to be subsequently used (substitute liquid).

In addition, the object of the present invention is to provide a program and a storage medium storing the program that is configured to perform a substrate processing method capable of, after a process to a substrate using a liquid (process liquid), rapidly and more reliably substituting the liquid remaining on the substrate with a liquid to be subsequently used (substitute liquid).

Further, the present invention relates to a substitute agent to be supplied onto a substrate so as to be substituted for a liquid remaining on a surface of the substrate. In particular, the object of the present invention is to provide a substitute agent capable of being rapidly and more reliably substituted for the liquid.

In the above JP2003-297794A and JP2005-5469A, there has been proposed that a substitute liquid having a lower surface tension (e.g., hydrofluoroether) is used as a substitute liquid, whereby a process liquid remaining on a substrate is rapidly substituted. Meanwhile, the inventors of the present invention had studied in detail an influence on the progress of substitution, which is caused by not only the surface tension but also by the density of the substitute liquid. Then, the inventors found that the density of the substitute liquid as well as the surface tension of the substitute liquid has a great impact on the rapidity of substitution and the reliability of the substitution. Namely, the present invention is based on this research. According to the present invention, as compared with the conventional technique, after a process to a substrate by using a process liquid, the process liquid remaining on the substrate can be more reliably substituted with a substitute liquid for a shorter period of time.

The substrate processing method according to the present invention is a substrate processing method comprising:

processing a substrate by a process liquid; supplying a substitute liquid onto the substrate and substituting the process liquid remaining on the substrate with the substitute liquid; and drying the substrate, after the process liquid has been substituted with the substitute liquid; wherein the substitute liquid used in the substitution of the process liquid has a surface tension that is smaller than a surface tension of the process liquid, and a density that is equal to a density of the process liquid.

In the substrate processing method according to the present invention, the substitute liquid used in the substitution of the process liquid and the process liquid may be soluble in each other.

In addition, in the substrate processing method according to the present invention, the substitute liquid used in the substitution of the process liquid may be more volatile than the process liquid.

Further, in the substrate processing method according to the present invention, the process liquid may be a liquid formed of a water. In the substrate processing method according to the present invention, the substitute liquid used in the substitution of the process liquid may be a mixed liquid of a water-insoluble liquid whose specific gravity is larger than 1 and a water-soluble liquid whose specific gravity is smaller than 1. Alternatively, in the substrate processing method according to the present invention, the substitute liquid used in the substitution of the process liquid may be a mixed liquid of a water-insoluble liquid and a water-soluble liquid. In the substrate processing method according to the present invention, the water-insoluble liquid may include at least one of perfluorocarbon, hydrofluorocarbon, hydrofluoroether, hydro-chlorofluorocarbon, and fluorine-based alcohol. In addition, in the substrate processing method according to the present invention, the water-soluble liquid may include at least one of aliphatic alcohols, ketones, esters, and glycols.

Further, in the substitution of the process liquid, of the substrate processing method according to the present invention, a steam of the substitute liquid may supplied to an area surrounding the substrate, and the steam may condense on the substrate so that the substitute liquid is supplied onto the substrate. In the substrate processing method according to the present invention, the substitute liquid used in the substitution of the process liquid may be a mixed liquid composed of two or more kinds of liquids, and the steam of the substitute liquid to be supplied to the area surrounding the substrate may be generated by supplying preset amounts of the respective two or more kinds of liquids to a heating device and heating them by the heating device.

The substrate processing apparatus according to the present invention is a substrate processing apparatus comprising: a holding unit configured to hold a substrate; a process-liquid supply part configured to supply a process liquid for processing the substrate; a substitute-agent supply part configured to supply a substitute liquid having a surface tension that is smaller than a surface tension of the process liquid, and a density that is equal to a density of the process liquid; and a control device configured to control supply of the process liquid by the process-liquid supply part and supply of the substitute liquid by the substitute-agent supply part, such that the process liquid remaining on the substrate is substituted with the substitute liquid.

The substrate processing apparatus according to the present invention may further comprise: a plurality of ducts configured to respectively supply plural kinds of liquids to be mixed with each other so as to constitute the substitute liquid; and a mixing unit connected to the respective ducts and the substitute-agent supply part; wherein the control device further controls supply of the liquids from the ducts, such that preset amounts of the respective liquids are respectively supplied from the respective ducts to the mixing unit and mixed with each other by the mixing unit so as to generate the substitute liquid.

Alternatively, in the substrate processing apparatus according to the present invention, the control device may control discharge of the water from the process-liquid supply part and discharge of a steam of the substitute liquid from the substitute-agent supply part, such that the steam of the substitute liquid is supplied to an area surrounding the substrate that has been processed with the use of the water, and that the water remaining on the substrate is substituted with the substitute liquid having condensed on the substrate.

The substrate processing apparatus according to the present invention may further comprise: a plurality of ducts configured to respectively supply plural kinds of liquids to be mixed with each other so as to constitute the substitute liquid; a mixing unit connected to the respective ducts; and a heating device disposed between the mixing unit and the substitute-agent supply part; wherein the control device may further control supply of the liquids from the ducts and heating by the heating device, such that preset amounts of the respective liquids are respectively supplied from the respective ducts to the mixing unit and mixed with each other by the mixing unit, and that the mixture of the liquids is thereafter heated by the heating device so as to generate the steam of the substitute liquid. Alternatively, the substrate processing apparatus according to the present invention may further comprise: a plurality of ducts configured to respectively supply plural kinds of liquids to be mixed with each other so as to constitute the substitute liquid; and a heating and mixing unit connected to the ducts and the substitute-agent supply part; wherein the control device may further control supply of the liquids from the ducts and heating by the heating and mixing unit, such that preset amounts of the respective liquids are respectively supplied from the respective ducts to the heating and mixing unit, and that the liquids are mixed with each other and heated by the heating and mixing unit so as to generate the steam of the substitute liquid. Alternatively, the substrate processing apparatus according to the present invention may further comprise: a plurality of ducts configured to respectively supply plural kinds of liquids to be evaporated and mixed with each other so as to constitute the steam of the substitute liquid; heating devices configured to heat the respective ducts; and a mixing unit connected to the ducts and the substitute-agent supply part; wherein the control device may further control heating by the heating devices and supply of the liquids from the ducts, such that preset amounts of the liquids are respectively supplied from the respective ducts to the mixing unit while the liquids are heated by the heating devices, and mixed by the mixing unit so as to generate the steam of the substitute liquid. In such a substrate processing apparatus, the generated steam of the substitute liquid may be discharged from the substitute-agent supply part along with a carrier gas, e.g., a carrier gas formed of nitrogen gas.

In the substrate processing apparatus according to the present invention, the holding unit may hold one substrate such that the substrate is oriented along a horizontal direction. Alternatively, in the substrate processing apparatus according to the present invention, the holding unit may simultaneously hold a plurality of substrates such that the substrates are oriented along a vertical direction.

In addition, in the substrate processing apparatus according to the present invention, the substitute liquid and the process liquid may be soluble in each other.

Further, in the substrate processing apparatus according to the present invention, the substitute liquid may be more volatile than the process liquid.

Furthermore, in the substrate processing apparatus according to the present invention, the holding unit may hold the substrate so as to be rotatable, and the control device may control the holding unit such that the substrate is dried while the substrate is being rotated, after the process liquid has been substituted with the substitute liquid.

Still furthermore, in the substrate processing apparatus according to the present invention, the process liquid may be a liquid formed of a water.

The program according to the present invention is a program executable by a control device configured to control a substrate processing apparatus, the program making the substrate processing apparatus, upon execution by the control device, perform a substrate processing method comprising: processing a substrate by a process liquid; supplying a substitute liquid onto the substrate and substituting the process liquid remaining on the substrate with the substitute liquid; and drying the substrate, after the process liquid has been substituted with the substitute liquid; wherein the substitute liquid used in the substitution of the process liquid has a surface tension that is smaller than a surface tension of the process liquid, and a density that is equal to a density of the process liquid.

The program storage medium according to the present invention is a storage medium storing a program executable by a control device configured to control a substrate processing apparatus, the program making the substrate processing apparatus, upon execution by the control device, perform a substrate processing method comprising: processing a substrate by a process liquid; supplying a substitute liquid onto the substrate and substituting the process liquid remaining on the substrate with the substitute liquid; and drying the substrate, after the process liquid has been substituted with the substitute liquid; wherein the substitute liquid used in the substitution of the process liquid has a surface tension that is smaller than a surface tension of the process liquid, and a density that is equal to a density of the process liquid.

The substitute agent according to the present invention is a substitute agent to be supplied to an object to be processed so as to be substituted for a liquid remaining on a surface of the object to be processed, wherein the substitute agent in a liquid state has a surface tension that is smaller than a surface tension of the liquid to be substituted, and the substitute agent in a liquid state has a density that is equal to a density of the liquid to be substituted.

The substitute agent according to the present invention may be soluble in the liquid to be substituted.

In addition, the substitute agent according to the present invention may be more volatile than the liquid to be substituted.

Further, in the substitute agent according to the present invention, the liquid to be substituted may be a water. Such a substitute agent according to the present invention may be a mixed liquid of a water-insoluble liquid whose specific gravity is larger than 1 and a water-soluble liquid whose specific gravity is smaller than 1. Alternatively, the substitute agent according to the present invention may be a mixed liquid of a water-insoluble liquid and a water-soluble liquid. In the substitute agent according to the present invention, the water-insoluble liquid may include at least one of perfluorocarbon, hydrofluorocarbon, hydrofluoroether, hydro-chlorofluorocarbon, and fluorine-based alcohol. In addition, in the substitute agent according to the present invention, the water-soluble liquid may include at least one of aliphatic alcohols, ketones, esters, and glycols.

### BRIEF DESCRIPTION OF THE DRAWINGS

FIG. 1 is a longitudinal sectional view of a substrate processing apparatus, showing a schematic structure of the substrate processing apparatus, for explaining a first embodiment of the present invention.

FIG. 2 is a top view of the substrate processing apparatus shown in FIG. 1.

FIG. 3 is a view for explaining substitution of a process liquid with a substitute liquid on a surface of a wafer W.

FIG. 4 is a longitudinal sectional view of a substrate processing apparatus, showing a schematic structure of the substrate processing apparatus for explaining a second embodiment of the present invention.

FIG. 5 is an enlarged view of the substrate processing apparatus shown in FIG. 4.

### EMBODIMENTS FOR CARRYING OUT THE INVENTION

Embodiments of the present invention will be described herebelow with reference to the drawings. Given in the following embodiments as an example to describe the present invention is a case where a substrate processing apparatus according to the present invention is applied to a cleaning apparatus (substrate processing apparatus) for cleaning (processing) a semiconductor wafer (substrate). In addition, given in the following embodiments as an example to describe the present invention is a case where a substrate processing method according to the present invention is applied to a method of cleaning a substrate (substrate cleaning method) in which a substrate, which has been processed by a chemical liquid, is rinsed by a water (process liquid), the water remaining on the substrate is then substituted with a substitute liquid, and thereafter, a liquid is removed from the substrate so as to dry the substrate. However, the embodiments described below are nothing more than mere application examples of the present invention, and the substrate processing method and the substrate processing apparatus according to the present invention can be applied to a cleaning process to a substrate other than a semiconductor wafer, and to a process other than the cleaning process. In addition, a substitute agent according to the present invention can be used for substituting a liquid remaining on a surface of an object to be processed that is not limited to a substrate.

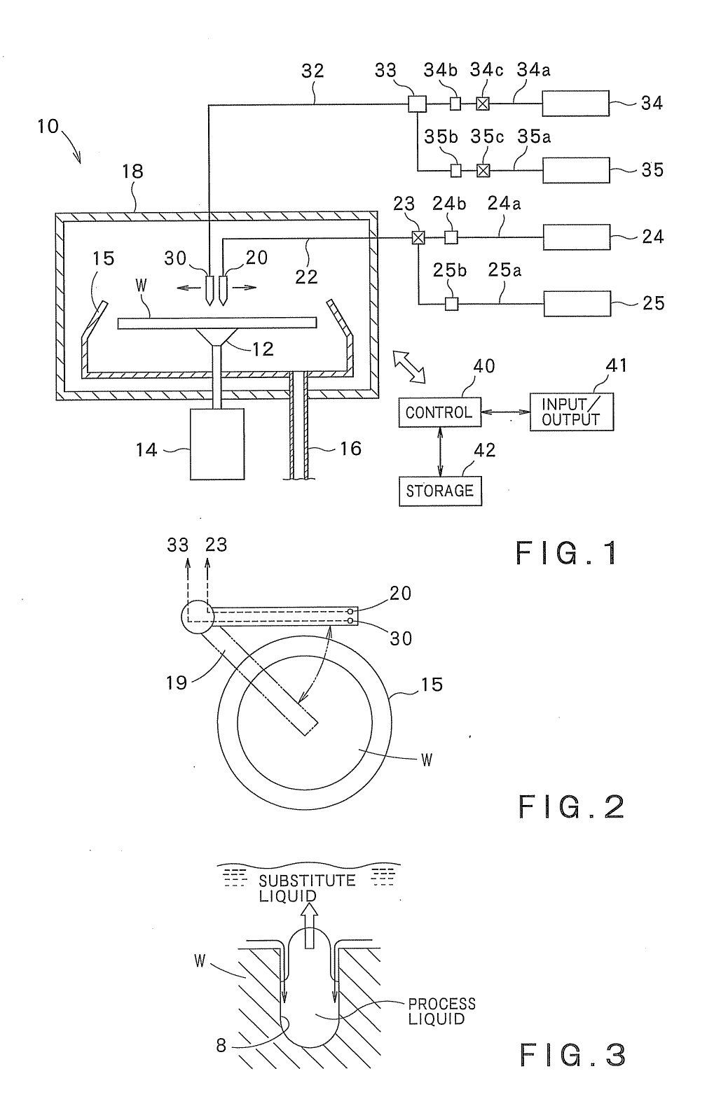

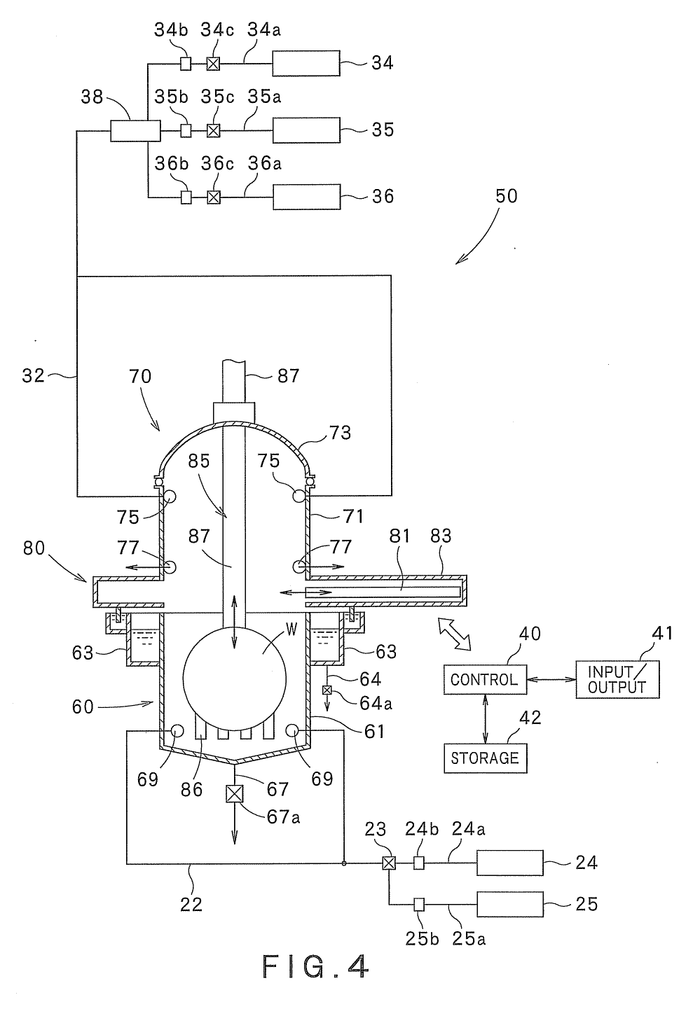

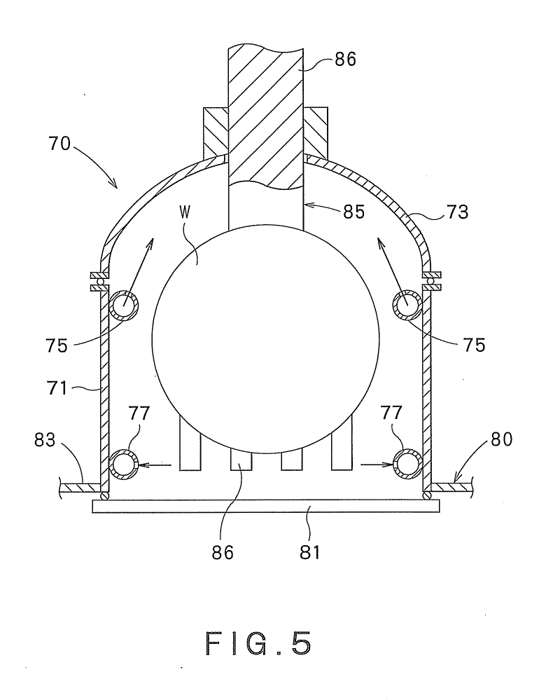

FIGS. 1 to 5 are views for explaining embodiments of a substrate processing method, a substrate processing apparatus, a program, and a program storage medium according to the present invention. FIGS. 1 to 3 are views for explaining a first embodiment for a single-wafer process in which a semiconductor wafer (hereinafter referred to simply as “wafer”) is processed one by one. FIGS. 4 and 5 are views for explaining a second embodiment for a batch process in which a batch of semiconductor wafers are simultaneously processed.

### First Embodiment

With reference to FIGS. 1 to 3, the first embodiment relating to the single-wafer process is described. FIG. 1 is a longitudinal sectional view of the substrate processing apparatus showing a schematic structure thereof, and FIG. 2 is a top view of the substrate processing apparatus.

As shown in FIG. 1, in this embodiment, a substrate processing apparatus 10 comprises: a holding unit 12 configured to hold a wafer W; a process-liquid supply part 20 configured to discharge a process liquid for processing the wafer W; and a substitute-agent supply part 30 configured to discharge a substitute liquid (substitute agent) for substituting the process liquid remaining on the wafer W. The substitute agent (substitute substance) is a concept including all the substitute liquid (i.e., fluid), the steam of the substitute liquid (i.e., gas), and the concretion of the substitute liquid (i.e., solid).

As shown in FIG. 1, the holding unit 12 is disposed in a casing 18. In this embodiment, the holding unit 12 is structured as a spin chuck for holding a wafer W in place by suction and rotating the wafer W. As shown in FIG. 1, the holding unit 12 is adapted to suck one wafer W such that a surface to be processed of the wafer W is oriented along a horizontal direction. The holding unit 12 is connected to a driving unit 14 such as a motor. When the holding unit 12 is driven by the driving unit 14, the holding unit 12 can be rotated, together with the wafer W held by the holding unit 12, about a shaft center along a vertical direction.

As shown in FIGS. 1 and 2, disposed in the casing 18 is a cup 15 that surrounds the wafer W held by the holding unit 12 from at least the horizontal direction. An exhaust/drain pipe 16 is extended from a bottom part of the cup 15 to the outside of the casing 18. A liquid collected in the cup 15 and an atmosphere in the casing 18 are discharged outside the casing 18 through the exhaust/drain pipe 16.

In this embodiment, the process-liquid supply part (process-liquid supply member) 20 and the substitute-agent supply part (substitute-agent supply member) 30 are formed by separate nozzles, respectively. The process-liquid supply part 20 and the substitute-agent supply part 30 are supported by, e.g., a slidable arm, or a swingable arm 19 as shown in FIG. 2. When the arm 19 is moved, the process-liquid supply part 20 and the substitute-agent supply part 30 can be horizontally moved above the wafer W held by the holding unit 12, specifically, between a position above a central portion of the wafer W and a position outside the wafer W.

As shown in FIG. 1, one end of a process-liquid supply duct 22 is connected to the process-liquid supply part 20. The other ends of the process-liquid supply duct 22 are connected to a plurality of ducts 24a and 25a via a switching valve 23. The respective ducts 24a and 25a are connected to process-liquid storage units 24 and 25 that store process liquids for processing a wafer W. The respective ducts 24a and 25a are provided with flowrate control valves 24b and 25b that respectively adjust flowrates of fluids flowing through the respective ducts 24a and 25a. In this embodiment, the substrate processing apparatus includes the deionized-water storage unit 24 storing a deionized water (DIW) and the chemical-liquid storage unit 25 storing a chemical liquid. Due to the above structure, by operating the switching valve 23 and the flowrate control valves 24a and 25a, a predetermined process liquid can be supplied from the selected process-liquid storage unit 24 or 25, by means of, e.g., a lifting power of a pump as a driving force, and discharged from the process-liquid supply part 20 at a predetermined flow rate.

As the process-liquid storage units 24 and 25, known storage units such as tanks can be used. The chemical liquid stored in the chemical-liquid storage unit 25 can be suitably selected from various known chemical liquids, such as diluted hydrofluoric-acid solution (DHF), ammonium-hydrogen peroxide solution (SC1), and sulfate-hydrogen peroxide solution (SC2), depending on a process to be performed by the substrate processing apparatus 10.

Next, a system of the substitute-agent supply part 30 is described. As shown in FIG. 1, one end of a substitute-agent supply duct 32 is connected to the substitute-agent supply part 30. Other ends of the substitute-agent supply duct 32 are connected to a plurality of ducts 34a and 35a via a mixer (mixing device, mixing unit) 33. The respective ducts 34a and 35a are connected to a plurality of liquid storage units 34 and that respectively store plural kinds of liquids (substitute-agent elements) which are mixed with each other to form a substitute liquid. The respective ducts 34a and 35a are provided with flowrate control valves 34a and 35a that respectively adjust flow rates of fluids flowing through the respective ducts 34a and 35a, and opening/closing valves 34c and 35c that respectively open and close the ducts 34a and 35a. Due to the above structure, by operating the flowrate control valves 34b and 35b and opening/closing valves 34c and 35c, predetermined amounts of substitute-agent elements are supplied from the respective liquid storage units 34 and 35 to the mixer 33, by means of, e.g., a lifting power of a pump as a driving force. Thus, a substitute liquid (liquid of the substitute agent) having a desired composition can be generated, and discharged from the substitute-agent supply part 30. Similarly to the process-liquid storage units 24 and 25, known storage units such as tanks can be used as the liquid storage units 34 and 35.

In this embodiment, the substrate processing apparatus 10 includes the two liquid storage units 34 and 35. Namely, in this embodiment, the substitute liquid discharged from the substitute-agent supply part 30 is composed of two kinds of liquids, to be more specific, two kinds of organic solvents. In this embodiment, the substitute liquid composed of the two kinds of liquids satisfy all the following conditions (1) to (4).

(1) The substitute liquid has a surface tension that is smaller than a surface tension of the process liquid to be substituted with the substitute liquid.
(2) The substitute liquid has a mass density that is equal to a mass density of the process liquid to be substituted with the substitute liquid.
(3) The substitute liquid and the process liquid to be substituted with the substitute liquid are soluble in each other.
(4) The substitute liquid is more volatile than the process liquid to be substituted with the substitute liquid.

Herein, the condition (2) in which the substitute liquid has a density that is equal to that of the process liquid means that, under a certain common condition, a ratio of the density of the substitute liquid with respect to the density of the process liquid is 1.0, when rounding off the value to first decimal place. Namely, in a case where the process liquid to be substituted with the substitute liquid is a deionized water, it can be expressed that the density of a substitute liquid is equal to the density of the deionized water, when the substitute liquid has the density ranging from not less than 0.95 g/cm³ to less than 1.05 g/cm³.

A degree of the volatility is judged based on a degree of latent heat of vaporization, under a certain common condition. Namely, when the latent heat of vaporization of the substitute liquid is lower than the latent heat of vaporization (about 2256 J/g) of a deionized water, it can be expressed that the substitute liquid is more volatile than the deionized water.

Such a substitute liquid is preferably a mixed liquid of a water-insoluble liquid and a water-soluble liquid. This is because, in all the cases wherein a process liquid to be substituted with the substitute liquid is a water, a water-soluble liquid, or a water-insoluble water, the substitute liquid and the process liquid can be soluble in each other, whereby the condition (3) can be satisfied. Especially, it is more preferable that the substitute liquid is a mixed liquid in which a water-insoluble liquid and a water-soluble liquid are mixed with each other as two kinds of substitute-agent elements, with a specific gravity of the water-insoluble liquid being larger than 1, when the process liquid to be substituted with the substitute liquid is regarded as a standard reference material (standard substance), and a specific gravity of the water-soluble liquid being smaller than 1, when the process liquid to be substituted with the substitute liquid is regarded as a standard reference material (standard substance). It is easy to obtain such substitute-agent elements, and thus the condition (2) can be satisfied by adjusting a mixing ratio between the two kinds of substitute-agent elements.

By way of example, the liquid stored in one of the liquid storage units may be a water-soluble liquid including at least one of: aliphatic alcohols such as methanol, ethanol, 1-propanol (n-propanol), 2-propanol (IPA: isopropyl alcohol), 1-butanol, 2-butanol, isobutanol, tert-butanol, tert-pentanol, 3-methyl-2-butanol, and cyclohexanol; ketones such as acetone and methyl ketone (MEK); esters; and glycols. On the other hand, the liquid stored in the other liquid storage unit may be a water-insoluble liquid including at least one of: perfluorocarbons such as C₆F₁₄, C₇F₁₆, and C₈F₁₈; hydrofluorocarbons such as CF₃CF₂CFHCFHCF₃; hydrofluoroethers such as C₄F₉OCH₃; hydro-chlorofluorocarbons such as C₃HC₁₂F₅, and fluorine-based alcohols such as CF₃CH₂OH, (CF₃)₂CHOH, (CF₃)₃COH, HCF₂CF₂CH₂OH, and HCF₂CF₂CF₂CF₂CH₂OH.

The substrate processing apparatus 10 further includes a control device 40 configured to control the aforementioned respective structural elements. More specifically, the control device 40 is electrically connected to the above-described holding unit 12, the driving unit 14, the arm 19, and the respective valves, and controls operations of these equipments. Connected to the control device 40 are a keyboard through which a command can be inputted by a process manager or the like so as to manage the substrate processing apparatus 10, and an input/output device 41 formed of a display or the like that makes visible an operating state of the substrate processing apparatus 10. In addition, the control device 40 is accessible to a storage medium 42 storing a program or the like to realize a process performed by the substrate processing apparatus 10. The storage medium 42 may be formed of a known program storage medium such as a memory such as a ROM and a RAM, and a disc-shaped storage medium such as a hard disc, a CD-ROM, a DVD-ROM, and a flexible disk.

Next, an example of the substrate processing method that can be performed by the substrate processing apparatus 10 as structured above is described. Operations of the respective structural elements for performing the below-described substrate processing method are controlled by means of control signals from the control device 40 based on the program previously stored in the program storage medium 42.

As described above, the following substrate processing method is a cleaning method of a wafer W, including a step in which a wafer W is cleaned by a chemical liquid, a step in which the wafer W, which has been processed by the chemical liquid, is rinsed by a process liquid (deionized water), a step in which a substitute liquid is applied to the rinsed wafer W so that the process liquid (deionized water) remaining on the wafer W is substituted with the substitute liquid, and a step in which the substitute liquid is removed from the wafer W so as to dry the wafer W. Herebelow, the respective steps are described in detail.

Firstly, a wafer W to be processed is loaded into the casing 18 and held by the holding unit 12. At this time, the wafer W is sucked and held by the holding unit 12 such that a plate surface of the wafer W is oriented along the horizontal direction. Based on a signal from the control device 40, the driving unit 14 drives and rotates the holding unit 12 and the wafer W. Simultaneously with this operation, the arm 19 is moved such that the process-liquid supply part 20 is located on a position directly above the central portion of a surface to be processed of the wafer W.

Under this state, based on a signal from the control device 40, the switching valve 23 and the flowrate control valve 25b are operated, so that a chemical liquid is discharged from the process-liquid supply part 20 at a predetermined flow rate. The discharged chemical liquid is supplied onto the central portion of the surface to be processed of the wafer W, and is spread from the central portion of the surface of the wafer W to the peripheral portion thereof in accordance with the rotation of the wafer W. In this manner, the surface of the wafer W is exposed to the chemical liquid and processed. Then, based on a control signal from the control device 40, the switching valve 23 is operated so that the discharge of the chemical liquid from the process-liquid supply part 20 is stopped, whereby the chemical-liquid cleaning step using the chemical liquid as a process liquid is finished. The chemical liquid, which is spun off outward from the wafer W by a centrifugal force caused by the rotation of the wafer W, is collected in the cup 15, and is discharged outside the casing 18 through the exhaust/drain pipe 16.

Next, the rinsing step is described. Firstly, based on a control signal from the control device 40, the switching valve 23 and the flowrate control valve 24b are operated. Thus, a deionized water as a process liquid is discharged from the process-liquid supply part 20 at a predetermined flow rate. The discharged deionized water is supplied onto the central portion of the surface to be processed of the wafer W, and is spread from the central portion of the surface of the wafer to the peripheral portion thereof in accordance with the rotation of the wafer W. In this manner, the chemical liquid on the wafer W is substituted with the deionized water. Then, based on a signal from the control device 40, the switching valve 23 is operated so that the discharge of the deionized water from the chemical-liquid supply part 20 is stopped, whereby the rinsing step using the deionized water as a process liquid is finished. The chemical liquid and the deionized water, which are spun off outward from the wafer W by a centrifugal force caused by the rotation of the wafer W, are collected in the cup 15, and are discharged outside the casing 18 through the exhaust/drain pipe 16.

In the above chemical-liquid cleaning step and the rinsing step, the process-liquid supply part 20 may be moved by the arm 19 along the plate surface of the wafer W from the position above the central portion of the wafer W toward the peripheral portion thereof, while the process-liquid supply part 20 discharges the process liquid. According to this manner, the process liquid discharged from the process-liquid supply part 20 can extend and spread over all the surface of the wafer W for a short period of time. In addition, in the chemical-liquid cleaning step and the rinsing step, after the discharge of the process liquid has been stopped, it is preferable to rotate the wafer W for a predetermined period of time, preferably, at a high speed. According to this manner, at the start of the succeeding step, an amount of the process liquid remaining on the wafer W can be considerably reduced.

Next, the substituting step is described. Firstly, based on a control signal from the control device 40, the opening/closing valves 34c and 35c and the flowrate control valves 34b and 35b are operated. Thus, a first liquid (e.g., IPA: isopropyl alcohol) as a first substitute-agent element flows from the first liquid storage part 34 to the mixer 33 at a predetermined flow rate, and a second liquid (e.g., hydrofluoroether) as a second substitute-agent element flows from the second liquid storage part 35 to the mixer 33. In the mixer 33, there is generated a substitute liquid (substitute agent in a liquid state) as a mixed liquid of the first liquid and the second liquid. The generated substitute liquid flows through the duct 32 so as to be discharged from the substitute-agent supply part 30 at a predetermined flow rate. The discharged substitute liquid is supplied onto the central portion of the surface of the wafer W, and is spread from the central portion of the surface of the wafer W to the peripheral portion thereof.

Then, the substitute agent substitutes for the deionized water remaining on the surface of the wafer W, and occupies the surface of the wafer W.

The substitute liquid discharged from the substitute-agent supply part 30 satisfies the aforementioned conditions (1) to (3). With the use of such a substitute liquid, the process liquid (deionized water) to be substituted can be stably and reliably substituted with the substitute liquid for a significantly short period of time. Although a mechanism resulting in this phenomenon is not clearly known, a possible mechanism considered as one of factors is described below with reference to FIG. 3. However, the present invention is not limited to the following mechanism.

As described above, the substitute liquid has a surface tension that is smaller than a surface tension of the process liquid to be substituted (above condition (1)). For example, the substitute liquid, which is formed of hydrofluoroether having a surface tension of about 13 to 15 dyn/cm and isopropyl alcohol having a surface tension of about 20 dyn/cm, has a surface tension that is lower than a surface tension (about 72 dyn/cm) of the deionized water to be substituted. Thus, as shown in FIG. 3, as compared with the process liquid (deionized water) to be substituted, the substitute liquid can more rapidly extend and spread over the surface of the wafer W. Even when fine irregularities (projections and recesses) such as wiring patterns are formed in the surface of the wafer W, the substitute liquid can more easily enter the recess 8, as compared with the deionized water to be substituted.

In addition, the substitute liquid has a density that is equal to a density of the process liquid to be substituted (above condition (2)). In the present invention, the same density means that a value of a ratio of the density of the substitute liquid to be substituted in a liquid state with respect to the density of the process liquid in a liquid states is 1.0, when rounding off the value to first decimal place. For example, when hydrofluoroether in a liquid state, which has a mass density of about 1.4 to 1.7 g/cm³, and isopropyl alcohol in a liquid state, which has a mass density of about 0.7 to 0.8 g/cm³, are mixed with each other, with a volume ratio therebetween being 4:6 to 5:5, the generated substitute liquid can have a mass density equal to that of the deionized water to be substituted.

It can be considered that, when the surface tension of the substitute liquid is lower than the surface tension of the process liquid to be substituted, the substitute liquid can extend and spread along the irregularities of the surface of the wafer W, so that the entering of the substitute liquid into the recess 8 filled with the process liquid to be substituted can be promoted. However, as shown in FIG. 3, in order that the substitute liquid enters the recess 8, the process liquid already contained in the recess 8 should be displaced from the recess 8. Namely, the area occupied by the process liquid up to then and the area occupied by the substitute liquid up to then should be replaced with each other. In particular, in the wafer W which is held such that the plate surface thereof is horizontally extended, there are a number of substantially vertically extending recesses. In this case, it is supposed that the process liquid to be substituted with the substitute liquid is difficult to be separated from the surface of the wafer W, because of the influence of gravity.

According to this embodiment, since the substitute liquid has the mass density identical to that of the process liquid to be substituted, wherever the process liquid remains on the surface of the wafer W, the influence caused by the gravity can be eliminated. Thus, it is supposed that the substitute liquid having the lower surface tension can displace the process liquid which has been in contact with the surface of the wafer W so far, and can extend and spread along the surface of the wafer W, whereby the process liquid remaining on the positions on the surface of the wafer W can be more reliably substituted with the substitute liquid for a short period of time.

There is described an experiment conducted by the inventors of the present invention to examine the effect which is given to a substitute efficiency by a ratio (mass density ratio) of the mass density of the substitute liquid with respect to the mass density of the process liquid to be substituted. Firstly, there was prepared a tube having an inside diameter of 0.4 mm and a length of 15 mm, with one end thereof being closed. The tube was made of PFA (tetrafluoroethylene perfluoroalkylvinyl ether copolymer). The tube was filled with a liquid to be substituted and immersed into the substitute liquid. After 30 seconds, 60 seconds, and 90 seconds from when the tube had been immersed into the substitute liquid, there was measured a length (mm) of the substitute liquid, at which the substitute liquid had displaced the liquid to be processed and entered the tube from an opening of the tube. The liquid to be substituted was a mixture of a deionized water and a slight amount of colorant, and a density of the liquid to be substituted was 0.975 g/cm³. On the other hand, the substitute liquid was a mixture of isopropyl alcohol having a density of 0.786 g/cm³ and the following hydrofluoroethers. The hydrofluoroethers were HFE7100 (composition: C₄F₉OCH₃, density: 1.520 g/cm³), HFE7200 (composition C₄F₉OC₂H₅, density: 1.430 g/cm³), and HFE7300 (composition: C₆F₁₃OCH₃, density: 1.660 g/cm³) which were available from 3M company. The various substitute liquids were generated by changing a mixing ratio between the hydrofluoroether and the isopropyl alcohol.

Table 1 shows an experiment result in which the substitute liquid formed of a mixed liquid of HFE7100 and the isopropyl alcohol was used. Table 2 shows an experiment result in which the substitute liquid formed of a mixed liquid of HFE7200 and the isopropyl alcohol was used. Table 3 shows an experiment result in which the substitute liquid formed of a mixed liquid of HFE7300 and the isopropyl alcohol was used. From Tables 1 to 3, it can be understood that, when a ratio (mass density ratio) of the mass density of the substitute liquid with respect to the mass density of the process liquid to be substituted was 1.0, an excellent substitute efficiency could be obtained.

TABLE 1
HFE-7100 (C₄F₉OCH₃)

| | mixing | | immersion | | |
|---|---|---|---|---|---|
| density | ratio (wt %) | | period (sec) | | |
| ratio | 7100 | IPA | 30 | 60 | 90 |
| 1.6 | 100 | 0 | 0 | 0 | 0 |
| 1.4 | 90 | 10 | 1.5 | 1.5 | 1.5 |
| 1.2 | 70 | 30 | 2.0 | 2.0 | 2.0 |
| 1.1 | 60 | 40 | 1.5 | 1.5 | 1.5 |
| 1.0 | 40 | 60 | 1.5 | 3.0 | 3.5 |
| 0.9 | 20 | 80 | 0.5 | 1.0 | 1.0 |
| 0.8 | 10 | 90 | 0.5 | 0.5 | 0.5 |
| 0.8 | 0 | 100 | 0.5 | 0.5 | 0.5 |

TABLE 2
HFE7200 (C₄F₉OC₂H₅),

| | mixing | | immersion | | |
|---|---|---|---|---|---|
| density | ratio (wt %) | | period (sec) | | |
| ratio | 7200 | IPA | 30 | 60 | 90 |
| 1.5 | 100 | 0 | 0 | 0 | 0 |
| 1.2 | 80 | 20 | 3.0 | 3.0 | 3.0 |
| 1.2 | 70 | 30 | 2.5 | 2.5 | 2.5 |
| 1.1 | 60 | 40 | 2.0 | 2.0 | 2.0 |
| 1.0 | 50 | 50 | 4.5 | 5.0 | 5.0 |
| 1.0 | 40 | 60 | 3.0 | 4.0 | 4.0 |
| 0.9 | 30 | 70 | 1.0 | 1.0 | 1.0 |
| 0.8 | 10 | 90 | 0.5 | 0.5 | 0.5 |
| 0.8 | 0 | 100 | 0.5 | 0.5 | 0.5 |

TABLE 3
HFE7300 (C₆F₁₃OCH₃)

| | mixing | | immersion | | |
|---|---|---|---|---|---|
| density | ratio (wt %) | | period (sec) | | |
| ratio | 7300 | IPA | 30 | 60 | 90 |
| 1.7 | 100 | 0 | 0 | 0 | 0 |
| 1.5 | 90 | 10 | 0.5 | 0.5 | 0.5 |
| 1.4 | 80 | 20 | 2.0 | 2.0 | 2.0 |
| 1.3 | 70 | 30 | 1.0 | 1.0 | 1.0 |
| 1.2 | 60 | 40 | 2.0 | 2.0 | 2.0 |
| 1.1 | 50 | 50 | 4.0 | 4.0 | 4.0 |
| 1.0 | 40 | 60 | 5.0 | 8.0 | 10.0 |
| 0.9 | 20 | 80 | 1.0 | 1.5 | 1.5 |
| 0.8 | 10 | 90 | 0.5 | 0.5 | 1.0 |
| 0.8 | 0 | 100 | 0.5 | 0.5 | 0.5 |

In this embodiment, the substitute liquid and the process liquid to be substituted with the substitute liquid are soluble in each other (above condition (3)). As is well-known, hydrofluoroether is water-insoluble, and will not be stably mixed with a deionized water. On the other hand, isopropyl alcohol has a alcohol radical and thus is water-soluble. In addition, isopropyl alcohol, which is an organic solvent, and hydrofluoroether are soluble in each other (isopropyl alcohol and hydrofluoroether can be stably mixed with each other).

As a result, in this embodiment, the substitute liquid and the process liquid (deionized water) to be substituted are soluble in each other, and thus can be stably mixed with each other.

As shown in FIG. 3, a slight amount of the process liquid remaining in the recess 8 of the irregularities of the wafer W is covered with the substitute liquid, as the substitute liquid spreads over the wafer W. Then, when the substitute liquid extends along the fine surface shape of the surface of the wafer W and is likely to enter the fine recess 8 in which the process liquid remains, the process liquid is dissolved into the substitute liquid covering the process liquid, in accordance with the movement of the substitute liquid into the recess 8. Thus, according to this embodiment, the process liquid remaining on the wafer W can be more rapidly and more reliably substituted with the substitute liquid, and the process liquid can be displaced from the surface of the wafer W.

As described above, by supplying the substitute liquid satisfying the aforementioned conditions (1) to (3) concerning the relationships between the substitute liquid and the deionized water to be substituted to the wafer W, in the substituting step, the substitution of the rinse liquid remaining on the wafer W with the substitute liquid can be more reliably completed for a short period of time. When the substitution can be more reliably completed for a short period of time, a productivity can be improved, which is advantageous in terms of costs. Particularly, when the process liquid to be substituted is a deionized water as in this embodiment, there is a possibility that, when the deionized water is present on the wafer W for a long period of time, i.e., the deionized water is in contact with the surface of the wafer W for a long period of time, the deionized water may react with oxygen and a semiconductor constituting the wafer W, which invites generation of watermarks on the surface of the wafer W. Thus, due to the fact that the substitution with the substitute liquid can be more reliably completed for a short period of time, a high quality can be stably provided, while not only improving the productivity but also preventing the generation of watermarks. As a result, a throughput can be enhanced, which is more advantageous in terms of costs.

The substituting step proceeds as described above, and based on a control signal from the control device 40, the flowrate control valves 34b and 35b and the opening/closing valves 34c and 35c are operated again. Thus, the discharge of the substitute liquid from the substitute-agent supply part 30 is stopped, whereby the substituting step using, the substitute liquid is finished.

In the substituting step, it is possible to discharge the substitute liquid from the substitute-agent supply part 30, while the substitute-agent part 30 is moved from the position above the central portion of the wafer W to the peripheral part thereof. Alternatively, it is possible to discharge the substitute liquid from the substitute-agent supply part 30, while the substitute-agent supply part 30 is stopped on the position directly above the central portion of the surface of the wafer W. In addition, in order to prevent the substitute liquid from being spun off from the wafer W before the substitute liquid discharged from the substitute-agent supply part 30 enters the fine recess 8 of the wafer W, it is preferable that the holding unit 12 rotates the wafer W at a low speed, or that the holding unit 12 stops the rotation thereof.

Next, the drying step is described. Firstly, based on a control signal from the control device 40, the driving unit 14 rotates the holding unit 12 and the wafer W at a high speed. Thus, the substitute liquid on the wafer W is spun off outward from the wafer W. In this embodiment, as described above, the substitute liquid is more volatile than the process liquid to be substituted with the substitute liquid (above condition (4)). For example, the substitute liquid, which is formed of a mixed liquid of hydrofluoroether having a latent heat of vaporization of about 100 to 130 J/g and isopropyl alcohol having a latent heat of vaporization of about 670 μg, has a latent heat of vaporization that is lower than a latent heat of vaporization (about 2259 j/g) of the deionized water to be substituted. Therefore, the substitute liquid having entered the fine recess 8 in the surface of the wafer W evaporates for a short period of time. Since the substitute liquid is spun off from the wafer W and the substitute liquid evaporates, the substitute liquid is removed from the surface of the wafer W. Thus, the wafer W is dried, and the rotation of the holding unit 12 driven by the driving means 14 is stopped, whereby the drying step is finished.

During this drying step, it is preferable that a gas (e.g., nitrogen gas) of a high temperature is blown toward the wafer W held by the holding unit, so that the surface of the wafer W is heated.

When the surface of the wafer W is heated as described above, the evaporation of the substitute liquid remaining on the wafer W is promoted, whereby the time required for drying the wafer W can be reduced.

After the series of processes to the wafer W have been finished, the processed wafer W is unloaded from the casing 18. Then, another wafer W to be subsequently processed is loaded into the casing 18, and the wafer W thus loaded is similarly subjected to the processes.

According to the above embodiment, the substitute liquid has a surface tension that is smaller than a surface tension of the process liquid. Thus, as compared with the process liquid, the substitute liquid can more rapidly extend and spread over the surface of the wafer W. In addition, even when fine irregularities such as wiring patterns are formed in the surface of the wafer W, the substitute liquid can easily enter the recess 8 of the irregularities. Further, according to this embodiment, the substitute liquid has a density that is equal to a density of the process liquid. Thus, without being influenced by the gravity, the process liquid and the substitute liquid can be easily mixed with each other. Namely, the process liquid can easily move from the surface of the wafer W into the substitute liquid. Since the substitute liquid can easily enter an area in which the process liquid to be substituted remains as well as the process liquid remaining on the wafer W can easily enter the substitute liquid, the process liquid remaining on the wafer W can be rapidly and more reliably substituted with the substitute liquid, so that the process liquid can be separated from the surface of the wafer W.

Thus, even when the process liquid is a water, a time period when the water is present on the wafer W, in other words, a time period when the water is in contact with the wafer W, can be reduced. Accordingly, generation of watermarks can be remarkably restrained.

In addition, according to this embodiment, the substitute liquid and the process liquid are soluble in each other. Thus, when the substitute liquid and the process liquid are in contact with each other at least at a certain part, the substitute liquid and the process liquid can be mixed with each other. Therefore, the process liquid remaining on the wafer W, i.e., a slight amount of the process liquid remaining in the recess 8 of the irregularities of the wafer, can be dissolved into the substitute liquid that gradually extends and spreads over the surface of the wafer W. That is to say, the entering of the process liquid remaining on the wafer W into the substitute liquid can be further promoted. Thus, according to this embodiment, the process liquid remaining on the wafer W can be more rapidly and more reliably substituted with the substitute liquid, so that the process liquid can be displaced from the surface of the wafer W.

Further, according to the present invention, the substitute liquid is more volatile than the process liquid. Thus, as compared with a case in which the process liquid is dried directly, the substitute liquid remaining on the wafer W can be rapidly evaporated, whereby the wafer W can be dried for a short period of time.

The above first embodiment relating to the single-wafer process can be variously modified.

For example, in the above first embodiment, there has been described the example in which the substitute liquid (substitute agent in a liquid state) is discharged from the substitute-agent supply part 30. However, not limited thereto, the substitute-agent supply duct 32 may be equipped with a heater, and a steam of the substitute liquid can be discharged from the substitute-agent supply part 30 into the casing 18. According to this manner, since the substitute agent (steam of the substitute agent) condenses on the surface of the wafer W, so that the substitute liquid can be applied to the surface of the wafer W.

In addition, the structures of the respective supply parts (nozzles) 20 and 30, the ducts, and the pipes in the above first embodiment can be suitably modified. For example, the process-liquid supply part 20 and the substitute-agent supply part 30 may be structured by a common nozzle.

In addition, in the above embodiment, there has been described the example in which predetermined amounts of the plural kinds of substitute-liquid elements are sent into the mixer 33, so that the substitute liquid formed of a mixture of the plural kinds of substitute-liquid elements is generated. However, not limited thereto, a substitute liquid formed by mixing plural kinds of substitute-liquid elements may be made in advance, and this substitute liquid may be stored in a liquid supply unit. However, in the case where the substitute liquid is previously made by mixing plural kinds of substitute-liquid elements and stored, there is a possibility that the substitute-liquid elements may be separated and/or the composition of the substitute liquid may be changed, because of difference in properties (e.g., volatility) between the plural kinds of substitute-liquid elements. Thus, when a substitute liquid is generated by using plural kinds of substitute-liquid elements of considerably different properties, it is preferable that the substitute liquid is generated by mixing the substitute-liquid elements with each other by the mixer (mixing unit, mixing device) 33, immediately before the substitute liquid is supplied.

Further, in the above first embodiment, there is the rinsing step by means of a deionized water, which is taken by way of example, and the embodiment is not limited thereto. As disclosed in JP2005-5469A, the rinsing, step by a deionized water may be omitted, and the chemical liquid as a process liquid may be substituted with the substitute liquid. Also in this modification, by selecting the substitute liquid which satisfies the aforementioned conditions (1) to (4) defining the relationships between the substitute liquid and the chemical liquid (process liquid) to be used, the effects corresponding to the above-described respective conditions can be independently obtained.

### Second Embodiment

Next, with reference to FIGS. 4 and 5, the second embodiment relating to a batch type process is described. FIG. 4 is a longitudinal sectional view of a substrate processing apparatus, showing a schematic structure of the substrate processing apparatus in the second embodiment, and FIG. 5 is an enlarged view of the substrate processing apparatus in the second embodiment. In FIGS. 4 and 5, the same parts as those of the first embodiment are shown by the same reference numbers, and the overlapping detailed description is omitted.

As shown in FIGS. 4 and 5, a substrate processing apparatus 50 comprises: an immersion part 60 containing a process liquid, into which wafers W can be immersed and processed; a drying part 70 configured to dry the wafers W which have been immersed in the process liquid and processed; a holding unit 85 configured to hold the wafers W; and a shutter mechanism 80 interposed between the immersion part 60 and the drying part 70. The shutter mechanism 80 includes a shutter box 83 interposed between the immersion part 60 and the drying part 70, and a shutter body 81 held by the shutter box 83. Disposed in the immersion part 60 is a process-liquid supply part (process-liquid supply member) 69 configured to discharge a process liquid for processing the wafers W. On the other hand, the drying part 70 is provided with a substitute-agent supply part (substitute-agent supply member) 75 configured to discharge a steam of a substitute liquid (substitute agent) for substituting the process liquid remaining on the wafers W. Herebelow, the respective structural elements are described.

Firstly, the holding unit 85 is described. In this embodiment, the holding unit 85 is structured as a wafer boat including four holding members 86 extending in the substantially horizontal direction (direction perpendicular to the planes of FIGS. 4 and 5), and a support column member 87 joined to the four holding members 86 and extending in the substantially vertical direction. The holding members 86 can simultaneously support a plurality of wafers to be simultaneously processed, e.g., fifty wafers, from below. Thus, each of the holding members 86 has grooves (not shown) arranged at predetermined intervals therebetween along the longitudinal direction of the holding member 86. Wafers W are engaged with the grooves and held by the holding members 86 such that the plate surfaces of the respective wafers W are substantially perpendicular to the direction in which the holding members 86 are extended, i.e., the plate surfaces of the respective wafers W are oriented along the vertical direction.

On the other hand, the support column member 87 is extended through a lid member 73 of the drying part 70 described below. The support column member 87 is joined to an elevation mechanism, not shown. By the driving of the elevation mechanism, the support column member 87 can be elevated and lowered along the vertical direction. Due to the movement of the support column member 87 along the vertical direction, as shown in FIGS. 4 and 5, the support column member 87 can be moved between the immersion part 60 and the drying part 70.

Next, the immersion part 60 is described. As shown in FIG. 4, the immersion part 60 includes a processing tank 61 having an upper opening, a recovery tank 63 circumferentially surrounding the upper opening of the processing tank 61 from outward, and an outer tank 65 circumferentially surrounding the recovery tank 63 from outward. As shown in FIG. 4, the processing tank 61 can accommodate the holding members 86 of the holding unit 85 together with a plurality of wafers W held by the holding members 86. Connected to a bottom part of the processing tank 61 is a drain pipe 67 provided with an opening/closing valve 67a. A liquid stored in the processing tank 61 can be discharged from the processing tank 61 through the drain pipe 67.

As shown in FIG. 4, two process-liquid supply parts 69 are disposed in the processing tank 61. In this embodiment, each of the process-liquid supply parts 69 is formed as an elongated cylindrical member extending along a direction in which the holding members 86 of the holding unit 85 accommodated in the processing tank 61 are extended. The cylindrical member has discharge holes (not shown) which are formed at substantially the same pitches as arrangement pitches of the wafers W held by the holding members 86. The process-liquid supply parts 69 are respectively held by opposed inner wall surfaces of the processing tank 61. Preferably, each liquid-processing supply part 69 is positioned such that each discharge hole is located between the two adjacent wafers W held by the holding members 86 so as to discharge a process liquid to a space between the wafers W.

In the second embodiment, as shown in FIG. 4, the process-liquid supply parts 69 are connected to process-liquid storage units 24 and 25 through a process-liquid supply duct 22. Structures of the ducts and the pipes of the second embodiment, which are disposed upstream side of the process-liquid supply parts 69, are the same as those of the above first embodiment.

The recovery tank 63 is a tank adapted to collect a process liquid overflowing from the processing tank 61. As shown in FIG. 4, joined to the recovery tank 63 is a drain pipe 64 provided with an opening/closing valve 64a. The liquid collected in the recovery tank 63 can be discharged from the recovery tank 63 through the drain pipe 64.

As shown in FIG. 4, the outer tank 63 is adapted to receive a circumferential projecting wall 84 projecting from the shutter mechanism 80. When the projecting wall 84 enters a liquid stored in the outer tank 65, an area inward the outer tank 65 and the projecting wall 84 can be blocked from outside.

Next, the drying part 70 is described. As shown in FIGS. 4 and 5, the drying part 70 includes a cylindrical body 71 having an upper opening and a lower opening, and the lid member 73 for covering the upper opening of the cylindrical body 71. As shown in FIG. 4, the cylindrical body 71 is located such that the lower opening of the cylindrical body 71 and the upper opening of the processing tank 61 are opposed to each other. As shown in FIG. 5, the shutter body 81 of the shutter mechanism 80 can close the lower opening of the cylindrical body 71. As shown in FIG. 5, inside a chamber of the drying part 70, which is defined by the cylindrical body 71, the lid member 73, and the shutter body 81, the holding members 86 of the holding unit 85 together with a plurality of wafers W held by the holding member 86 can be accommodated. The lid member 73 can be elevated and lowered along the vertical direction by the driving of an elevation mechanism, not shown. Thus, the lid member 73 can be separated from the cylindrical body 71.

As shown in FIGS. 4 and 5, two substitute-agent supply parts 75 are disposed in the processing tank 61. In this embodiment, each of the substitute-agent supply parts 75 is formed as an elongated cylindrical member extending along a direction in which the holding members 86 of the holding unit 85 are extended. The cylindrical member has discharge holes (not shown) which are formed at substantially the same pitches as arrangement pitches of the wafer W held by the holding members 86. The substitute-agent supply parts 75 are respectively held by opposed inner wall surfaces of the cylindrical body 71. Preferably, each substitute-agent supply part 75 is positioned such that each discharge hole is located between the two adjacent wafers W held by the holding members 86 so as to discharge a steam of a substitute liquid to a space between the wafers W.

As shown in FIG. 4, the substitute-agent supply parts 75 are connected to a heating and mixing unit (heating and mixing device) 38 through a substitute-agent supply duct 32. As shown in FIG. 4, similarly to the first embodiment, the substitute-agent supply duct 32 is connected to a plurality of liquid storage units 34 and 35 respectively storing plural kinds of liquids (substitute-agent elements) to be mixed with each other so as to constitute a substitute liquid. The heating and mixing unit 38 also functions as a mixer (mixing device, mixing unit), and generates a substitute agent by mixing fluids flowing through the substitute-agent supply duct 32. In addition, the heating and mixing unit 38 also functions as a heater, and can heat plural kinds of liquids (substitute-agent elements) to be mixed with each other so as to evaporate the liquids.

Due to this structure, by operating the flowrate control valves 34b and 35b and the opening/closing valves 34c and 35c, predetermined amounts of the respective substitute-agent elements can be supplied from the respective liquid storage units 34 and 35 to the heating and mixing unit 38 by means of, e.g., a lifting power of a pump as a driving force. Then, the heating and mixing unit 38 can heat and evaporate the predetermined amounts of the liquids from the respective liquid storage units 34 and 35. Thus, a predetermined amount of a steam of the substitute liquid (substitute agent) having a desired composition can be generated, and the generated steam can be discharged from the substitute-agent supply parts 75.

In the second embodiment, similarly to the above first embodiment, the substrate processing apparatus 50 includes the two liquid storage units 34 and 35. Namely, in this embodiment, the substitute agent to be discharged from the substitute-agent supply parts 75 becomes a steam of a mixed liquid composed of the two kinds of liquids, to be more specific, a steam of a mixed liquid (substitute liquid) composed of the two kinds of organic solvents. In this embodiment, the mixed liquid (substitute liquid) composed of the two kinds of liquids satisfy all the following conditions (1) to (4) which are the same as those of the first embodiment. In other words, the steam discharged from the substitute-agent supply parts 75 satisfies all the following conditions (1) to (4), when the steam is in a liquid state. In order to satisfy these conditions, the liquids stored in the liquid storage units 34 and 35 can be selected in the similar manner as that of the above first embodiment.

(1) The substitute liquid has a surface tension that is smaller than a surface tension of the process liquid to be substituted with the substitute liquid.
(2) The substitute liquid has a mass density that is equal to a mass density of the process liquid to be substituted with the substitute liquid.
(3) The substitute liquid and the process liquid to be substituted with the substitute liquid are soluble in each other.
(4) The substitute liquid is more volatile than the process liquid to be substituted with the substitute liquid.

As shown in FIG. 4, in this embodiment, the substitute-agent supply duct 32 is connected to a nitrogen storage unit 36 through a duct 36a provided with a flowrate control valve 36b and an opening/closing valve 36c. By operating the flowrate control valve 36b and the opening/closing valve 36c, a predetermined amount of nitrogen gas is supplied from the nitrogen storage unit 36 to the heating and mixing unit 38. Then, the nitrogen gas, which has been heated to a predetermined temperature by the heating and mixing unit 38, can be supplied to the drying part 70 at a predetermined flow rate. When the aforementioned steam of the substitute liquid is generated, by supplying a predetermined amount of nitrogen gas from the nitrogen storage unit 36 to the heating and mixing unit 38, the generated steam of the substitute liquid is discharged along with a carrier gas formed of the nitrogen gas, from the substitute-agent supply parts 75. As the nitrogen storage unit 36, a known storage unit such as a tank can be used.

As shown in FIGS. 4 and 5, connected to the drying part 70 is an exhaust pipe 77 for exhausting the drying part 70.

Also in the second embodiment, the substrate processing apparatus 50 includes a control device 40, an input/output device 41, and a storage medium 42 (see, FIG. 4), which are similar to those of the above first embodiment.

Next, an example of the substrate processing method that can be performed by the substrate processing apparatus 50 as structured above is described. Operations of the respective structural elements for performing the below-described substrate processing method are controlled by control signals from the control device 40 based on the program previously stored in the program storage medium 42.

Similarly to the first embodiment, the following substrate processing method is a cleaning method of wafers W, including a step in which wafers W are cleaned by a chemical liquid, a step in which the wafers W, which have been processed by the chemical liquid, are rinsed by a process liquid (deionized water), a step in which a substitute liquid is applied to the rinsed wafers W so that the process liquid (deionized water) remaining on the wafers W is substituted with the substitute liquid, and a step in which the substitute liquid is removed from the wafers W so as to dry the wafers W. Herebelow, the respective steps are described in detail.

Firstly, the lid member 73 is elevated, and the holding members 86 of the holding unit 85 are elevated to a position outside the cylindrical body 71. Then, wafers W to be processed are placed on the holding members 86 of the holding unit 85 so as to be held by the holding unit 85. At this time, the plurality of wafers W are simultaneously held by the holding unit 85 such that plate surfaces of the respective wafers W are oriented along the vertical direction. The holding unit 85 holding the wafers W is lowered to a position where the wafers W are located inside the processing tank 61. In addition, the lid member 73 is lowered to a position where the lid member 73 is in contact with the cylindrical body 71.

Prior to these operations, or simultaneously with these operations, based on a signal from the control device 40, the switching valve 23 and the flowrate control valve 25b are operated so that a chemical liquid is discharged from the process-liquid supply parts 69 into the processing tank 61 at a predetermined flow rate. Before the wafers W are accommodated in the processing tank 61, the processing tank 61 is filled with the chemical liquid. As a result, when the wafers W are lowered by the holding unit 85 so as to be accommodated in the processing tank 61, the wafers W are immersed into the chemical liquid. In this manner, the surfaces of the wafers W are exposed to the chemical liquid and processed. During this cleaning step, the chemical liquid may be continuously discharged from the process-liquid supply parts 69, or the supply of the chemical liquid may be stopped. The chemical liquid overflowing from the processing tank 61 is collected in the recovery tank 63. The chemical liquid collected in the recovery tank 63 is drained, discarded, or circulated into the processing tank 61, through the drain pipe 64.

Next, the rinsing step is described. Firstly, based on a control signal from the control device 40, the switching valve 23 and the flowrate control valve 24b are operated. Thus, a deionized water as a process liquid is supplied from the process-liquid supply parts 69 into the processing tank 61 at a predetermined, flow rate. The chemical liquid contained in the processing tank 61 overflows from the processing tank 61 to the recovery tank 63, and then the chemical liquid is drained through the drain pipe 64. In this manner, the chemical liquid in the processing tank 61 is substituted with the deionized water, so that the wafers W held by the holding unit 85 are rinsed. During this rinsing step, the deionized water is preferably continuously discharged from the process-liquid supply parts 69. The deionized water, which has overflown from the processing tank 61, overflows from the processing tank 61 to the recovery tank 63, is drained through the drain pipe 64.

In the above-described rinsing step, there has been described the example in which the chemical liquid in the processing tank 61 is substituted with the deionized water discharged from the process-liquid supply parts 69, so that the wafers W are rinsed. However, not limited thereto, the chemical liquid stored in the processing tank 61 may be firstly drained through the drain pipe 67, and thereafter the processing tank 61 may be filled with a deionized water by discharging the deionized water from the process-liquid supply parts 69.

In addition, during at least one of the chemical-liquid cleaning step and the deionized-water rinsing step, it is preferable that, by operating the opening/closing valve 36c and the flowrate control valve 36b, a nitrogen gas is supplied into the drying part 70 so that the inside of the drying part 70 is filled with a nitrogen atmosphere. In addition, at the same time, by operating the heating and mixing unit 38, a nitrogen gas of a high temperature is supplied into the drying part 70 so as to heat an inner wall surface of the drying part 70. This is because, in the following substituting step, condensation of a steam of the substitute liquid, which has been discharged to the drying part 70, on the inner wall surface of the drying part 70 can be remarkably prevented, whereby the substitute liquid can be efficiently utilized.

Next, the substituting step is described. The holding unit 85 is elevated together with the wafers W held by the same. After the holding unit 85 and the wafers W have been loaded into the drying part 70, the shutter body 81 of the shutter mechanism 80 is slid with respect to the shutter box 83 so as to close the lower opening of the cylindrical body 71. Thus, the drying part 70 and the immersion part 60 are disconnected from each other.

Under this state, a predetermined amount of steam of the substitute liquid having a desired composition is discharged as a substitute agent from the substitute-agent supply parts 75 so as to be supplied to the drying part 70. Specifically, based on a signal from the control device 40, the opening/closing valves 34c and 35c and the flowrate control valves 34b and 35b are operated. Thus, a predetermined amount of a first liquid (e.g., IPA: isopropyl alcohol) as a first substitute-agent element flows from the first liquid storage part 34 into the heating and mixing unit 38, and a predetermined amount of a second liquid (e.g., hydrofluoroether) as a second substitute-agent element flows from the second liquid storage part 35 to the heating and mixing unit 38. In the heating and mixing unit 38, the first liquid and the second liquid are mixed and heated, and a predetermined amount of a substitute agent (steam of the substitute liquid) can be generated by the evaporation of the mixed liquid of the first liquid and the second liquid. Then, the predetermined amount of the steam is supplied through substitute-agent supply parts 75 to the area surrounding the wafers W accommodated in the drying part 70.

Simultaneously with the generation of such a substitute liquid, a nitrogen gas may be flown into the heating and mixing unit 38 by operating the opening/closing valve 36c and the flowrate control valve 36b. In this case, it is possible to stably and reliably supply the predetermined amount of the generated steam of the substitute liquid into the drying part 70.

Thus, the steam of the substitute liquid supplied to the area surrounding the wafers W condenses on the surfaces of the wafers W which have been drawn up from the deionized water stored in the processing tank 61. As a result, the substitute liquid is applied to the surfaces of the wafers W, so that a film of the substitute liquid is formed on each surface of the wafer W. Then, the deionized water remaining on each surface of the wafer W is substituted with the substitute liquid.

A supply ratio between the supply rate of the first liquid from the first liquid storage unit and the supply rate of the second liquid from the second liquid storage unit is determined such that the mixed liquid formed by mixing the first liquid and the second liquid at this supply ratio can satisfy the aforementioned conditions (1) to (4). Thus, the substitute liquid applied to the wafers W will satisfy the above conditions (1) to (4).

In a case where a mixed liquid previously formed by mixing the liquids at a predetermined mixing ratio is evaporated by a heating device and is sent into the drying part 70, there is a possibility that a composition of the mixed liquid before evaporation and a composition of the steam of the mixed liquid may differ from each other, because of difference in evaporation speeds of the respective liquids (respective substitute-liquid elements) forming the mixed liquid. However, according to this embodiment, since the required amounts of respective liquids are supplied from the separated liquid storage parts 34 and 35 to the heating and mixing unit 38 so as to generate a mixed liquid, it can be effectively prevented that a composition of the mixed liquid before evaporation and a composition of the steam of the mixed liquid differ from each other. Thus, the substitute liquid applied to the wafers W will satisfy the aforementioned conditions (1) to (4).

With the use of a substitute liquid satisfying the above conditions (1) to (3), as described in the first embodiment, the process liquid (deionized water) to be substituted can be stably and reliably substituted with the substitute liquid for a significantly short period of time.

Namely, when the substitute liquid has a surface tension that is smaller than a surface tension of the process liquid to be substituted (when the condition (1) is satisfied), as shown in FIG. 3, as compared with the deionized water to be substituted, the substitute liquid can more rapidly extend and spread over each surface of the wafer W. In addition, even when fine irregularities (projections and recesses) such as wiring patterns are formed in each surface of the wafer W, the substitute liquid can more easily enter a recess 8, as compared with the deionized water to be substituted.

In addition, when the substitute liquid has a density that is equal to that of the process liquid to be substituted with the substitute liquid (when the condition (2) is satisfied), the influence caused by the gravity on the relative movement of the substitute liquid and the process liquid can be eliminated, wherever the process liquid remains on the surface of the wafer W.

Thus, it is supposed that the substitute liquid having a lower surface tension displaces the process liquid, which has been in contact with the surface of the wafer W until then, and extends and spreads along the surface of the wafer W. In this case, the process liquid remaining on positions on each surface of the wafer W can be more reliably substituted with the substitute liquid.

In particular, a wiring pattern to be formed in a surface of a wafer W has recently become more complicated and smaller, and there are a lot of recesses extending in a direction other than a normal line direction of a plate surface of the wafer W, from a microscopic point of view. Thus, even when a wafer W is held such that a plate surface of the wafer W is oriented along the vertical direction, the condition (2) is greatly effective, with a view to improving the substitute efficiency.

Further, when the substitute liquid and the process liquid to be substituted with the substitute liquid are soluble in each other (when the condition (3) is satisfied), since the process liquid (deionized water) to be substituted can be dissolved into the substitute liquid, separation of the process liquid (deionized water) to be substituted from the surface of the wafer W can be considerably promoted. As shown in FIG. 3, a slight amount of the process liquid remaining in the recess 8 of the irregularities of the wafer W is covered with the substitute liquid, as the substitute liquid spreads over the wafer W. Then, when the substitute liquid extends along the fine surface shape of the surface of the wafer W and is likely to enter the fine recess 8 in which the process liquid remains, the process liquid is dissolved into the substitute liquid covering the process liquid, in accordance with the movement of the substitute liquid into the recess 8. Thus, according to this embodiment, the process liquid remaining on the wafer W can be more rapidly and more reliably substituted with the substitute liquid, so that the process liquid can be displaced from the surface of the wafer W.

As described above, by applying the substitute liquid, which satisfies the aforementioned conditions (1) to (3) defining the relationships between the substitute liquid and the deionized water to be substituted, to each surface of the wafer W, in the substituting step, the substitution of the rinse liquid remaining on the wafer W with the substitute liquid can be more reliably completed for a short period of time. When the substitution can be more reliably completed for a short period of time, a productivity can be improved, which is advantageous in terms of costs. Particularly, when the process liquid to be substituted is a deionized water as in this embodiment, generation of watermarks on the surface of the wafer W can be effectively prevented. Thus, due to the fact that the substitution with the substitute liquid can be more reliably completed for a short period of time, not only the productivity can be improved but also a high quality can be stably provided. At the same time, a throughput can be enhanced, which is more advantageous in terms of costs.

The substituting step proceeds as described above, and based on a control signal from the control device 40, the flowrate control valves 34b and 35b and the opening/closing valves 34c and 35c are operated again. Thus, the discharge of the steam of the substitute liquid from the substitute-agent supply parts 75 is stopped, whereby the substituting step using the substitute liquid is finished.

In the above-described substituting step, there has been described the example in which, after the wafers W have been loaded into the drying part 70 and the drying part 70 has been blocked from the immersion part 60 by the shutter body 81, the steam of the substitute liquid is discharged from the substitute-agent supply parts 75. However, not limited thereto, the steam of the substitute liquid may be started to be discharged from the substitute-agent supply parts 75, at an earlier timing than the above timing. For example, during the rinsing step, the steam of the substitute liquid may be started to be discharged from the substitute-agent supply parts 75. In this case, an atmosphere in the drying part 70 has been already formed by the steam of the substitute liquid, when the wafers W are drawn up from the processing tank 61.

Next, the drying step is described. Firstly, based on a control signal from the control device 40, the opening/closing valve 36c, the flowrate control valve 36b, and the heating and mixing unit 38 are operated, so that a nitrogen gas of a high temperature is supplied into the drying part 70. As a result, the inside of the drying part 70 is maintained at a high temperature, and thus the evaporation of the substitute liquid from each surface of the wafer W is promoted. In particular, according to this embodiment, as described above, the substitute liquid is more volatile than the process liquid to be substituted with the substitute liquid (above condition (4)). Thus, the substitute liquid in the fine recess 8 in the surface of the wafer W can be evaporated for a short period of time. Thus, the substitute liquid is removed from the surface of the wafer W, so that the wafer W is dried.

In this manner, the series of processes to the wafers W are finished. The lid member 73 is elevated, and under this state, the holding unit 85 holding the processed wafers W is elevated. Then, the processed wafers W are unloaded from the holding unit 85. Thereafter, other wafers to be subsequently processed are placed on the holding unit 85, and these wafers W are similarly subjected to the processes.

According to the above second embodiment, the same effects as those of the first embodiment can be obtained. Namely, since the substitute liquid has a surface tension that is smaller than a surface tension of the process liquid, the substitute liquid can more rapidly extend and spread over each surface of the wafer W, as compared with the process liquid. In addition, even when fine irregularities such as wiring patterns are formed in the surface of the wafer W, the substitute liquid can easily enter the recess 8 of the irregularities. Further, since the substitute liquid has a density that is equal to a density of the process liquid, the process liquid and the substitute liquid can be easily mixed with each other, without being influenced by the gravity. Namely, the process liquid can easily move from the surface of the wafer W into the substitute liquid. Since the substitute liquid can easily enter an area in which the process liquid to be substituted remains as well as the process liquid remaining on the wafer W can easily enter the substitute liquid, the process liquid remaining on each wafer W can be rapidly and more reliably substituted with the substitute liquid, so that the process liquid can be separated from the surface of the wafer W.

Thus, even when the process liquid is a water, a period when the water is present on the wafer W, in other words, a period when the water is in contact with the wafer W, can be reduced. Accordingly, generation of watermarks can be remarkably restrained.

In addition, by supplying the steam of the substitute liquid to the area surrounding the wafers W so as to condense the steam on each surface of the wafer W, the substitute liquid is applied to the surface of the wafer W. Thus, the amount of use of the substitute liquid can be remarkably decreased.

In addition, according to this embodiment, the substitute liquid and the process liquid are soluble in each other whereby the substitute liquid and the process liquid can be mixed with each other. Thus, the process liquid remaining on the wafer W, e.g., a slight amount of the process liquid remaining in the recess 8 of the irregularities of the wafer, can be mixed with the substitute liquid that gradually extends and spreads over the surface of the wafer W. That is to say, the entering of the process liquid remaining on the wafer W into the substitute liquid can be further promoted. Thus, according to this embodiment, the process liquid remaining on the wafer W can be more rapidly and more reliably substituted with the substitute liquid, so that the process liquid can be removed from the surface of the wafer W.

Further, according to this embodiment, since the substitute liquid is more volatile than the process liquid, the substitute liquid remaining on the wafer W can be rapidly evaporated, whereby the wafer W can be dried for a short period of time.

The second embodiment relating to the batch type process can be variously modified.

For example, in the above second embodiment, the steam of the substitute liquid is discharged from the substitute-agent supply parts 75. However, not limited thereto, a substitute agent that is not evaporated, i.e., the substitute liquid, may be discharged from the substitute-agent supply parts 75 toward the wafers W.

In addition, the structure of the respective supply parts (nozzles) 69 and 75, the ducts, and the pipes in the above second embodiment can be suitably modified. For example, in the above second embodiment, the deionized water and the chemical liquid are discharged from the common process-liquid supply parts 69. However, not limited thereto, the deionized water and the chemical liquid may be discharged from separate process-liquid supply parts. In addition, the steam of the substitute liquid and the nitrogen gas are discharged from the common substitute-agent supply parts 75, which is by way of example. Not limited, thereto, the steam of the substitute liquid and the nitrogen gas may be discharged from separate substitute-agent supply parts.

In the above embodiment, there has been described the example in which predetermined amounts of plural kinds of substitute-liquid elements are sent into the heating and mixing unit 38 serving both as a mixer and a heater, and the plural kinds of substitute-liquid elements are mixed and heated so as to generate the steam of the substitute liquid. However, not limited thereto, it is not always necessary that the storage units are disposed for each of the substitute-liquid elements. A substitute liquid formed by mixing the plural kinds of substitute-liquid elements may be generated in advance, and the substitute liquid may be stored in a liquid supply unit. However, in the case where the substitute liquid is previously generated by mixing plural kinds of substitute-liquid elements and stored, there is a possibility that the substitute-liquid elements may be separated and/or the composition of the substitute liquid may be changed, because of difference in properties (e.g., volatility) of the plural kinds of substitute-liquid elements. Thus, when a substitute liquid is generated by using plural kinds of substitute-liquid elements of considerably different properties, it is preferable that the substitute liquid is generated by mixing the substitute-liquid elements with each other by a mixer (mixing unit, mixing device), immediately before the substitute liquid is supplied.

Further, in the above embodiment, the substrate processing apparatus 50 includes, for example, the heating and mixing unit 38 serving both as a heater and a mixer. However, not limited thereto, the substrate processing apparatus 50 may include heating devices disposed on the respective ducts 34a and 35a, and a mixing unit (mixer, mixing device) connected to the respective ducts 34a and 35a and the substitute-agent supply duct 32. Namely, the substitute-agent elements in a liquid state may be respectively heated so as to separately generate steams of the plural kinds of substitute-agent elements, and thereafter the thus generated steams of the plural kinds of substitute-agent elements may be mixed with each other by a mixer (mixing unit, mixing device) so as to generate a steam of the substitute liquid. Alternatively, the substrate processing apparatus 50 may include a mixing unit (mixer, mixing device) connected to the ducts 34a and 35a and the substitute-agent supply duct 32, and a heating device disposed on the substitute-agent supply duct 32 at a position downstream the mixing unit. Namely, a substitute liquid may be generated by mixing plural kinds of substitute-agent elements in a liquid state, and thereafter the substitute liquid may be heated so as to generate a steam of the substitute liquid. In these modifications, the mixing unit is preferably located at a position occupied by the heating and mixing unit 38 in FIG. 4.

In the above second embodiment, although the wafers W are rinsed by, for example, immersing the wafers W into the deionized water stored in the processing tank 61, the embodiment is not limited thereto. As disclosed in JP2003-297794A, the drying part 60 may include a process-liquid supply part, such that wafers W can be subjected to a rinsing step by discharging a deionized water toward the wafers W in the drying part 60.

Furthermore, in the above second embodiment, there is the rinsing step by means of a deionized water, which is taken by way of example, and the embodiment is not limited thereto. As disclosed in JP2005-5469A, the rinsing step by a deionized water may be omitted, and the chemical liquid as a process liquid may be substituted with the substitute liquid. Also in this modification, by selecting the substitute agent in a liquid state which satisfies the aforementioned conditions (1) to (4) defining the relationships between the substitute liquid and the chemical liquid (process liquid) to be used, the effects corresponding to the above-described respective conditions can be independently obtained.

Hereinabove, there have been described the two embodiments as the application examples of the substrate processing apparatus and the substrate processing method according to the present invention. However, as described in the initial part of the description of the embodiments, the application of the substrate processing apparatus and the substrate processing method according to the present invention is not limited to the cleaning and the drying of a semiconductor wafer. For example, with the use of a substitute agent having a prominent property except a volatility, a process liquid, which remains on a substrate processed by means of the process liquid, may be substituted with the substitute liquid, and the substrate may be continuously subjected to a process (e.g., process other than a drying process) based on the prominent property of the substitute agent.

1. A substrate processing method comprising:
processing a substrate by a water;
supplying a substitute liquid onto the substrate and substituting the water remaining on the substrate with the substitute liquid; and
drying the substrate, after the water has been substituted with the substitute liquid;
wherein the substitute liquid used in the substitution of the water has a surface tension that is smaller than a surface tension of the water, and a density that is equal to a density of the water.

2. The substrate processing method according to claim 1, wherein
the substitute liquid used in the substitution of the water and the water are soluble in each other.

3. The substrate processing method according to claim 1, wherein
the substitute liquid used in the substitution of the water is more volatile than the water.

4. The substrate processing method according to claim 1, wherein
the substitute liquid used in the substitution of the water is a mixed liquid of a water-insoluble liquid and a water-soluble liquid.

5. The substrate processing method according to claim 4, wherein
a specific gravity of the water-insoluble liquid is larger than 1, and a specific gravity of the water-soluble liquid is smaller than 1.

6. The substrate processing method according to claim 4, wherein
the water-insoluble liquid includes at least one of perfluorocarbon, hydrofluorocarbon, hydrofluoroether, hydro-chlorofluorocarbon, and fluorine-based alcohol.

7. The substrate processing method according to claim 4, wherein
the water-soluble liquid includes at least one of aliphatic alcohols, ketones, esters, and glycols.

8. (canceled)

9. (canceled)

10. A substrate processing apparatus comprising:
a holding unit configured to hold a substrate;
a process-liquid supply part configured to supply a water for processing the substrate;
a substitute-agent supply part configured to supply a substitute liquid having a surface tension that is smaller than a surface tension of the water, and a density that is equal to a density of the water; and
a control device configured to control supply of the water by the process-liquid supply part and supply of the substitute liquid by the substitute-agent supply part, such that the water remaining on the substrate is substituted with the substitute liquid.

11. The substrate processing apparatus according to claim 10, wherein
the control device controls discharge of the water from the process-liquid supply part and discharge of the substitute liquid from the substitute-agent supply part, such that the substitute liquid is discharged onto the substrate that has been processed with the use of the water, and that the water remaining on the substrate is substituted with the substitute liquid.

12. The substrate processing apparatus according to claim 11, further comprising:
a plurality of ducts configured to respectively supply plural kinds of liquids to be mixed with each other so as to constitute the substitute liquid; and
a mixing unit connected to the respective ducts and the substitute-agent supply part;
wherein the control device further controls supply of the liquids from the ducts, such that preset amounts of the respective liquids are respectively supplied from the respective ducts to the mixing unit and mixed with each other by the mixing unit so as to generate the substitute liquid.

13. The substrate processing apparatus according to claim 10, wherein
the control device controls discharge of the water from the process-liquid supply part and discharge of a steam of the substitute liquid from the substitute-agent supply part, such that the steam of the substitute liquid is supplied to an area surrounding the substrate that has been processed with the use of the water, and that the water remaining on the substrate is substituted with the substitute liquid having condensed on the substrate.

14. (canceled)

15. (canceled)

16. (canceled)

17. The substrate processing apparatus according to claim 10, wherein
the holding unit holds one substrate such that the substrate is oriented along a horizontal direction.

18. The substrate processing apparatus according to claim 10, wherein
the holding unit simultaneously holds a plurality of substrates such that the substrates are oriented along a vertical direction.

19. The substrate processing apparatus according to claim 10, wherein
the substitute liquid and the water are soluble in each other.

20. The substrate processing apparatus according to claim 10, wherein
the substitute liquid is more volatile than the water.

21. The substrate processing apparatus according to claim 10, wherein
the holding unit holds the substrate so as to be rotatable, and
the control device controls the holding unit such that the substrate is dried while the substrate is being rotated, after the water has been substituted with the substitute liquid.

22. (canceled)

23. A storage medium storing a program executable by a control device configured to control a substrate processing apparatus, the program making the substrate processing apparatus, upon execution by the control device, perform the substrate processing method according to claim 1.

24-30. (canceled)
